(19) United States
(12) Patent Application Publication
(10) Pub. No.: US 2014/0280141 A1
(43) Pub. Date: Sep. 18, 2014

(54) METHOD AND SYSTEM FOR GROUPING AND CLASSIFYING OBJECTS IN COMPUTED TOMOGRAPHY DATA

(71) Applicant: MORPHO DETECTION, INC., Newark, CA (US)

(72) Inventor: Walter I. Garms, Berkeley, CA (US)

(73) Assignee: MORPHO DETECTION, INC., Newark, CA (US)

(21) Appl. No.: 13/829,162

(22) Filed: Mar. 14, 2013

(51) Int. Cl. G06F 17/30

(52) U.S. Cl. CPC G06F 17/30598
USPC 707/737

(57) ABSTRACT

A method for classifying objects in volumetric computed tomography (CT) data is described. The method is implemented by a computing device having a processor and a memory coupled to the processor. The method includes receiving, by the computing device, one or more volumetric CT data sets, identifying, by the computing device, a first object in the one or more volumetric CT data sets, identifying, by the computing device, a second object in the one or more volumetric CT data sets, determining, by the computing device, a first similarity amount between the first object and the second object, identifying, by the computing device, a first group comprising at least the first object and the second object, based at least in part on the first similarity amount, and designating, by the computing device, all of the objects in the first group as non-contraband.

### BACKGROUND OF THE INVENTION

The embodiments described herein relate generally to computed tomography, and more particularly to grouping and classifying objects that are detected in a computed tomography system.

In at least some known computed tomography (“CT”) imaging systems used for baggage scanning in airports, for example, a human operator (“user”) separately identifies each object that passes through a CT scanner. That is, in these known CT systems, multiple identical or similar objects are each individually reviewed by a user and classified as either contraband or non-contraband. For example, if one hundred similar bottles pass through the scanner, either sequentially or in one large container, one bottle may contain an explosive substance whereas the other bottles do not. The effort to review and determine whether each individual bottle represents contraband or non-contraband is put forth by the user of the scanner. The presence of a large number of nuisance alarms reduces the probability that a screener or user will correctly identify the true contraband item.

### BRIEF DESCRIPTION OF THE INVENTION

In one aspect, a method for classifying objects in volumetric computed tomography (CT) data is provided. The method is implemented by a computing device having a processor and a memory coupled to the processor. The method includes receiving, by the computing device, one or more volumetric CT data sets, identifying, by the computing device, a first object in the one or more volumetric CT data sets. The method additionally includes identifying, by the computing device, a second object in the one or more volumetric CT data sets, determining, by the computing device, a first similarity amount between the first object and the second object, identifying, by the computing device, a first group comprising at least the first object and the second object, based at least in part on the first similarity amount, and designating, by the computing device, all of the objects in the first group as non-contraband.

In another aspect, a computing device comprising a processor and a memory coupled to the processor is provided. The memory includes computer-executable instructions that, when executed by the processor, cause the computing device to receive one or more volumetric CT data sets. The instructions additionally cause the computing device to identify a first object in the one or more volumetric CT data sets, identify a second object in the one or more volumetric CT data sets, determine a first similarity amount between the first object and the second object, identify a first group comprising at least the first object and the second object, based at least in part on the first similarity amount, and designate all of the objects in the first group as non-contraband.

In another aspect, a computer-readable storage device having computer-executable instructions embodied thereon is provided. When executed by a computing device having a processor and a memory coupled to the processor, the computer-executable instructions cause the computing device to perform the steps of receiving one or more volumetric CT data sets and identifying a first object in the one or more volumetric CT data sets. The computer-executable instructions additionally cause the computing device to perform the steps of identifying a second object in the one or more volumetric CT data sets, determining a first similarity amount between the first object and the second object, identifying a first group comprising at least the first object and the second object, based at least in part on the first similarity amount, and designating all of the objects in the first group as non-contraband.

### BRIEF DESCRIPTION OF THE DRAWINGS

FIG. 1 is a perspective view of an imaging system in accordance with an exemplary embodiment of the present invention.

FIG. 2 is a block diagram of an exemplary computing device used with the imaging system of FIG. 1.

FIG. 3 is an exemplary user interface generated by the computing device of FIG. 2.

FIG. 4 is an exemplary user interface generated by the computing device of FIG. 2.

FIG. 5 is a flow chart of an exemplary method that may be implemented using the imaging system of FIG. 1 and the computing device of FIG. 2.

### DETAILED DESCRIPTION OF THE INVENTION

FIG. 1 is a perspective view of an exemplary imaging system 100 that includes a scanner 102 and a computing device 104. Imaging system 100 is used for viewing objects in a container 106, or pallet of containers, on a platform 108. For example, imaging system 100 may be used to detect contraband (e.g., explosives, drugs, weapons, or other prohibited objects) located in container 106. Platform 108 is configured to rotate clockwise and/or counter-clockwise and translate closer to and further away from a floor. Also included in scanner 102 is an x-ray source 110 and a plurality of x-ray detectors 112 for receiving x-rays emitted by x-ray source 110. As platform 108 rotates and translates with container 106 located on platform 108, x-ray source 110 emits x-rays that pass through container 106 and are received by x-ray detectors 112. X-ray detectors 112 convert the received x-rays into electrical signals representing x-ray projection data. Computing device 104 is communicatively coupled to scanner 102 and receives x-ray projection data from scanner 102. Computing device 104 converts x-ray projection data into volumetric CT data using computed tomography reconstruction algorithms. In some embodiments, computing device 104 is physically coupled to scanner 102 rather than being physically separate from scanner 102.

FIG. 2 is a block diagram of computing device 104. Computing device 104 includes a processor 202 for executing instructions. In some embodiments, executable instructions are stored in a memory area 204. Processor 202 may include one or more processing units (e.g., in a multi-core configuration). Memory area 204 is any device allowing information such as executable instructions and/or data to be stored and retrieved. Memory area 204 may include one or more computer readable storage device or other computer readable media, including transitory and non-transitory computer readable media.

Computing device 104 also includes at least one media output component 206 for presenting information to user 208. Media output component 206 is any component capable of conveying information to user 208. In some embodiments, media output component 206 includes an output adapter such as a video adapter and/or an audio adapter. An output adapter is operatively coupled to processor 202 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones). In some embodiments, at least one such display device and/or audio device is included in media output component 206.

In some embodiments, computing device 104 includes an input device 210 for receiving input from user 208. Input device 210 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 206 and input device 210.

Computing device 104 may also include a communication interface 212, which is communicatively couplable to a remote device such as scanner 102. Communication interface 212 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 204 are, for example, processor-executable instructions for providing a user interface to user 208 via media output component 206 and, optionally, receiving and processing input from input device 210. Memory area 204 may include, but is not limited to, any computer-operated hardware suitable for storing and/or retrieving processor-executable instructions and/or data. Memory area 204 may include random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). Further, memory area 204 may include multiple storage units such as hard disks or solid state disks in a redundant array of inexpensive disks (RAID) configuration. Memory area 204 may include a storage area network (SAN) and/or a network attached storage (NAS) system.

In some embodiments, memory area 204 includes memory that is integrated in computing device 104. In some embodiments, memory area 204 includes a database, for example a relational database. For example, computing device 104 may include one or more hard disk drives as memory area 204. Memory area 204 may also include memory that is external to computing device 104 and may be accessed by a plurality of computing devices. The above memory types are exemplary only, and are thus not limiting as to the types of memory usable for storage of processor-executable instructions and/or data. Computing device 104 contains, within memory area 204, processor-executable instructions for receiving one or more sets of volumetric CT data from scanner 102, and identifying, grouping, and classifying objects in the received volumetric CT data. As will be understood by those skilled in the art of object identification, an object may be created by an automatic examination of a CT volume to find contiguous voxels that can be formed into an object. Alternatively, an object could be defined by empty space around it, or by detecting a regular array of objects.

FIG. 3 is an exemplary user interface 300 generated by computing device 104. User interface is displayed by computing device 104 through media output component 206 (FIG. 2). User interface 300 includes an overview 302 in which volumetric CT data pertaining a first object group 304, a second object group 306, a third object group 308, and a fourth object group 310 is rendered and displayed. Computing device 104 receives volumetric CT data from scanner 102, detects separate objects, and groups the objects based on one or more characteristics.

In some embodiments, if all or a certain subset of characteristics for two or more objects are less than corresponding thresholds stored in memory area 204, computing device 104 determines that the objects are in the same group. In other embodiments, computing device 104 generates a total “distance” measurement by applying a weighting factor to each of the characteristics of objects scanned in scanner 102. In this context, “distance” is the inverse of “similarity”. For example, less “distance” means more “similarity”. If the total “distance” is less than a threshold value, computing device 104 determines that the objects are in the same group. As a group is built, computing device 104 determines an average value for each of the characteristics, such that a composite representation of the group is generated in memory area 204. Characteristics of subsequent objects must be within established thresholds (i.e., plus or minus a given amount) of the average values to be included in a particular group. Such a method prevents “creep” of the average values of the characteristics associated with a given group, which could otherwise occur when a first object is compared with a second object on an outside edge of characteristic values defining objects in the group. Characteristics that are evaluated in the methods described above include at least one of a mass, a volume, a density, a surface texture, a ratio of a surface area to volume, a first dimension, a ratio of the first dimension and to a second dimension, and a contour of a projection.

The object groups 304, 306, 308, and 310 displayed in overview 302 are located in container 106 (FIG. 1). In some embodiments, overview 302 may be scrollable or moveable such that other groups of objects may be displayed. In other embodiments, overview 302 is zoomable, to display greater or lesser image detail as desired by user 208 (FIG. 2). Groups 304, 306, 308, and 310 may be color coded such that objects within each group 304, 306, 308, and 310 have the same or similar colors, thereby visually indicating which group 304, 306, 308, or 310, if any, a particular object is in. First object group 304 includes a first plate 312, a second plate 314, a third plate 316, and a fourth plate 318. In some embodiments, objects in an object group are displayed in different colors to facilitate distinguishing them from each other. User interface 300 also includes a section 320 in which a representative object from a selected object group 304, 306, 308, or 310 is displayed. As illustrated in FIG. 3, plate 314 of first object group 304 is displayed in section 320. In some embodiments, section 320 displays a three-dimensional rendering of an object, such that user 208 may rotate the rendering to view the object from different angles and/or zoom in or out to view the object in greater or lesser detail.

User interface 300 includes a first field 322 that displays a total number of object groups 304, 306, 308, and 310 under review. More specifically, first field 322 displays the total number of groups that computing device 104 determined the objects in container 108 fell into, based on grouping methods such as those described above. User interface 300 additionally includes a second field 324 that displays a selected group number. User interface 300 also includes a third field 326 that displays a number of objects within the selected group. A decrease button 328 and an increase button 330 included in user interface 300 allow user 208 to increase or decrease the selected group number. When the selected group number is changed, computing device 104 causes overview 302 to be updated to visually indicate the selected group and causes section 320 to be updated to display a representative object from the selected group.

User interface 300 additionally includes a clear group button 332. When computing device 104 determines that user 208 has pressed clear group button 332, computing device 104 designates all objects in the selected group as non-contraband and stores the designation in memory area 204. Accordingly, user 208 is relieved of having to individually view each object in a group and determine whether each object in the group represents contraband or non-contraband. In some embodiments, computing device 104 performs a further step of decreasing the total number of groups in first field 322, such that the cleared group (i.e., formerly the selected group) is no longer selectable. In some embodiments, all objects are initially designated as contraband and one or more of the objects are subsequently designated as non-contraband as described above. User interface 300 additionally includes a radio button 334. When user 208 selects radio button 334, computing device 104 displays a user interface similar to user interface 400 (FIG. 4).

FIG. 4 is an exemplary user interface 400 that is generated by computing device 104 when user 208 selects radio button 334. User interface 400 has many elements in common with user interface 300 (FIG. 3). The common elements are labeled with the reference numbers from FIG. 3. First group 304 is the selected group in FIG. 4. Within first group 304 are four separate objects, which are plates 312, 314, 316, and 318. A fourth field 402 displays a selected object number within the selected group (i.e., first group 304). A decrease button 404, when pressed, decreases the selected object number displayed in fourth field 402. Similarly, an increase button 406, when pressed, increases the selected object number displayed in fourth field 402. Each time the selected object changes, computing device 104 updates section 320 to display the selected object. User interface 400 additionally includes a clear object button 408. When computing device 104 determines that clear object button 408 has been pressed, computing device 104 stores data pertaining to the selected object to a library in memory area 204. More specifically, characteristics pertaining to the selected object are stored in a library of non-contraband (i.e., allowed objects) in memory area 204. Thereafter, any objects that would be grouped with the selected object using one or more of the grouping methods described above are determined by computing device 104 to also be non-contraband.

When receiving volumetric CT data pertaining to one or more non-contraband, computing device 104, in some embodiments, will exclude the non-contraband from user interfaces 300 and 400, such that user 208 is not presented with them. In other embodiments, computing device 104 may display a notification through media output component 206 that the objects have been identified as non-contraband. By maintaining a library of non-contraband in memory area 204, comparing new objects to the library of non-contraband, and designating one or more new objects as non-contraband, user 208 is relieved of having to determine whether each object entering scanner 102 represents contraband or non-contraband.

To aid in comparing objects to each other, user interface 400 includes a set reference button 410 and a compare button 412. When computing device 104 determines that user 208 has pressed set reference button 410, computing device 104 stores a designation in memory area 204 that the selected object in section 320 is a reference object. By using decrease button 404 and/or increase button 406, user 208 may then select another object from the selected group (e.g., first group 304). User 208 may then press compare button 412. When computing device 104 determines that compare button 412 has been pressed, computing device 104 displays, through media output component 206, a comparison of the reference object and the selected object. In some embodiments, computing device 104 displays a comparison of the reference object and the selected object by alternately displaying the reference object and the selected object, such that differences and similarities between the reference object and the selected object may be readily perceived by user 208. In other embodiments, computing device 104 displays the reference object and the selected object adjacent to each other or with one overlaid on top of the other. In other embodiments, computing device 104 additionally or alternatively displays, through media output component 206, a listing of numerical values for the characteristics of the reference object and the selected object, such that user 208 may numerically compare the characteristics of the reference object and the selected object.

FIG. 5 is a flow chart of an exemplary method 500 that may be implemented using imaging system 100 (FIG. 1). At step 502, computing device 104 receives one or more volumetric CT data sets. The one or more volumetric CT data sets are generated by scanner 102 during the process of scanning one or more containers 106, as described with reference to FIG. 1. At step 504, computing device identifies a first object (e.g., first plate 312) in the one or more volumetric CT data sets. At step 506, computing device identifies a second object (e.g., second plate 314) in the one or more volumetric CT data sets. As described above and as will be understood by those skilled in the art, the identification of objects can be performed, for example, through automatic examination of a CT volume to find contiguous voxels that can be formed into an object, by detecting empty space around one or more objects, and/or by detecting a regular array of objects. At step 508, computing device 104 determines a first similarity amount between the first object (e.g., first plate 312) and the second object (e.g., second plate 314). At step 510, computing device 104 identifies a first group (e.g., first group 304) comprising at least the first object (e.g., first plate 312) and the second object (e.g., second plate 314), based at least in part on the first similarity amount. At step 512, computing device 104 designates all of the objects in the first group (e.g., at least first plate 312 and second plate 314) as non-contraband. In some embodiments for applications such as non-destructive testing, one or more objects and/or one or more groups of objects are designated by computing device 104 as contraband.

It should be understood that processor as used herein means one or more processing units (e.g., in a multi-core configuration). The term processing unit, as used herein, refers to microprocessors, microcontrollers, reduced instruction set circuits (RISC), application specific integrated circuits (ASIC), logic circuits, and any other circuit or device capable of executing instructions to perform functions described herein.

It should be understood that references to memory mean one or more devices operable to enable information such as processor-executable instructions and/or other data to be stored and/or retrieved. Memory may include one or more computer readable media, such as, without limitation, hard disk storage, optical drive/disk storage, removable disk storage, flash memory, non-volatile memory, ROM, EEPROM, random access memory (RAM), and the like.

Additionally, it should be understood that communicatively coupled components may be in communication through being integrated on the same printed circuit board (PCB), in communication through a bus, through shared memory, through a wired or wireless data communication network, and/or other means of data communication. Additionally, it should be understood that data communication networks referred to herein may be implemented using Transport Control Protocol/Internet Protocol (TCP/IP), User Datagram Protocol (UDP), or the like, and the underlying connections may comprise wired connections and corresponding protocols, for example, Institute of Electrical and Electronics Engineers (IEEE) 802.3 and/or wireless connections and associated protocols, for example, an IEEE 802.11 protocol, an IEEE 802.15 protocol, and/or an IEEE 802.16 protocol.

A technical effect of systems and methods described herein includes at least one of: (a) receiving, by a computing device, one or more volumetric CT data sets; (b) identifying, by the computing device, a first object in the one or more volumetric CT data sets; (c) identifying, by the computing device, a second object in the one or more volumetric CT data sets; (d) determining, by the computing device, a first similarity amount between the first object and the second object; (e) identifying, by the computing device, a first group comprising at least the first object and the second object, based at least in part on the first similarity amount; and (f) designating, by the computing device, all of the objects in the first group as non-contraband.

Exemplary embodiments of systems and method for grouping and classifying objects in computed tomography data are described above in detail. The methods and systems are not limited to the specific embodiments described herein, but rather, components of systems and/or steps of the methods may be utilized independently and separately from other components and/or steps described herein. For example, the methods may also be used in combination with other imaging systems and methods, and are not limited to practice with only the systems as described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for classifying objects in volumetric computed tomography (CT) data, said method implemented by a computing device having a processor and a memory coupled to the processor, said method comprising:
receiving, by the computing device, one or more volumetric CT data sets;
identifying, by the computing device, a first object in the one or more volumetric CT data sets;
identifying, by the computing device, a second object in the one or more volumetric CT data sets;
determining, by the computing device, a first similarity amount between the first object and the second object;
identifying, by the computing device, a first group comprising at least the first object and the second object, based at least in part on the first similarity amount; and
designating, by the computing device, all of the objects in the first group as non-contraband.

2. The method of claim 1, further comprising:
identifying, by the computing device, a third object in the one or more volumetric CT data sets;
determining, by the computing device, a second similarity amount between the third object and at least one of the first object, the second object, and a composite representation of the first group; and
identifying, by the computing device, the third object as being excluded from the first group, based at least in part on the second similarity amount.

3. The method of claim 1, further comprising:
identifying, by the computing device, a third object in the one or more volumetric CT data sets;
determining, by the computing device, a second similarity amount between the third object and at least one of the first object, the second object, and a composite representation of the first group; and
identifying, by the computing device, the third object as being included in the first group, based at least in part on the second similarity amount.

4. The method of claim 1, wherein said determining further comprises comparing a first characteristic of the first object to a second characteristic of the second object, wherein each of the first characteristic and the second characteristic is one of a mass, a volume, a density, a surface texture, a ratio of a surface area to a volume, a first dimension, a ratio of the first dimension and a second dimension, and a contour of a projection.

5. The method of claim 1, wherein the computing device further comprises a display device coupled to the processor, said method further comprising:
displaying, through the display device, the first object and the second object; and
displaying, through the display device, a visual indication that the first object and the second object are within the first group.

6. The method of claim 1, wherein the computing device further comprises an input device coupled to the processor and wherein said designating all objects in the first group as non-contraband further comprises receiving, through the input device, a designation that the first group is non-contraband.

7. The method of claim 1, wherein the computing device further includes a display device coupled to the processor, said method further comprising:
designating one of the first object and the second object as a representative object of the first group; and
displaying the representative object.

8. The method of claim 7, wherein the computing device further includes an input device coupled to the processor, said method further comprising:
receiving an instruction, through the input device, to compare the representative object to at least one other object; and
displaying, through the display device, a comparison of the representative object to the at least one other object.

9. The method of claim 1, further comprising storing, in the memory, the first object as a reference object that is designated as non-contraband.

10. The method of claim 1, wherein the memory comprises at least one reference object that is designated as non-contraband, said method further comprising:
retrieving, from the memory, the least one reference object that is designated as non-contraband;
comparing the first object to the at least one reference object; and
designating the first object as non-contraband, based at least in part on said comparing the first object to the at least one reference object.

11. The method of claim 10, wherein said designating that all of the objects in the first group are non-contraband is based at least is part on said designating the first object as non-contraband.

12. The method of claim 1, further comprising designating a second group of objects as contraband.

13. A computing device comprising a processor and a memory coupled to said processor, wherein said memory comprises computer-executable instructions that, when executed by said processor, cause said computing device to:
receive one or more volumetric CT data sets;
identify a first object in the one or more volumetric CT data sets;
identify a second object in the one or more volumetric CT data sets;
determine a first similarity amount between the first object and the second object;
identify a first group comprising at least the first object and the second object, based at least in part on the first similarity amount; and
designate all of the objects in the first group as non-contraband.

14. The computing device of claim 13, wherein said memory further comprises computer-executable instructions that, when executed by said processor, cause said computing device to:
identify a third object in the one or more volumetric CT data sets;
determine a second similarity amount between the third object and at least one of the first object, the second object, and a composite representation of the first group; and
identify the third object as being excluded from the first group, based at least in part on the second similarity amount.

15. The computing device of claim 13, wherein said memory further comprises computer-executable instructions that, when executed by said processor, cause said computing device to:
identify a third object in the one or more volumetric CT data sets;
determine a second similarity amount between the third object and at least one of the first object, the second object, and a composite representation of the first group; and
identify the third object as being included in the first group, based at least in part on the second similarity amount.

16. The computing device of claim 13, wherein said memory further comprises computer-executable instructions that, when executed by said processor, cause said computing device to store, in said memory, the first object as a reference object that is designated as non-contraband.

17. The computing device of claim 13, wherein said memory further comprises at least one reference object that is designated as non-contraband and computer-executable instructions that, when executed by said processor, cause said computing device to:
retrieve, from said memory, the least one reference object that is designated as non-contraband;
compare the first object to the at least one reference object; and
identify the first object as non-contraband, based at least in part on comparing the first object to the at least one reference object.

18. A computer-readable storage device having computer-executable instructions embodied thereon, wherein, when executed by a computing device having a processor and a memory coupled to the processor, cause the computing device to perform the steps of:
receiving one or more volumetric CT data sets;
identifying a first object in the one or more volumetric CT data sets;
identifying a second object in the one or more volumetric CT data sets;
determining a first similarity amount between the first object and the second object;
identifying a first group comprising at least the first object and the second object, based at least in part on the first similarity amount; and
designating all of the objects in the first group as non-contraband.

19. The computer-readable storage device of claim 18, further comprising computer-executable instructions that, when executed by the computing device, cause the computing device to perform the steps of:
identifying a third object in the one or more volumetric CT data sets;
determining a second similarity amount between the third object and at least one of the first object, the second object, and a composite representation of the first group; and
identifying the third object as being excluded from the first group, based at least in part on the second similarity amount.

20. The computer-readable storage device of claim 18, further comprising computer-executable instructions that, when executed by the computing device, cause the computing device to perform the steps of:
identifying a third object in the one or more volumetric CT data sets;
determining a second similarity amount between the third object and at least one of the first object, the second object, and a composite representation of the first group; and
identifying the third object as being included in the first group, based at least in part on the second similarity amount.
